(19) United States
(12) Patent Application Publication
(10) Pub. No.: US 2026/0303131 A1
(43) Pub. Date: Oct. 1, 2026

(54) RADIO FREQUENCY CIRCUIT

(71) Applicant: SUMITOMO ELECTRIC DEVICE INNOVATIONS, INC., Kanagawa (JP)

(72) Inventors: Kento KAWASAKI, Kanagawa (JP); Yukinori NOSE, Kanagawa (JP)

(21) Appl. No.: 19/559,158

(22) Filed: Mar. 6, 2026

(30) Foreign Application Priority Data
Mar. 25, 2025 (JP) 2025-050076

(51) Int. Cl. H04B 1/00; H04B 1/16

(52) U.S. Cl. CPC H04B 1/0078; H04B 1/1615

(57) ABSTRACT

A radio frequency circuit includes an output terminal; a first transistor including a first terminal, a second terminal, and a control terminal; a first circuit including a resistor and a first capacitor connected in series between a first node and a reference potential terminal to which a reference potential is supplied, the first node being provided between the second terminal and the output terminal, the first circuit being configured to pass, to the reference potential terminal, a signal component at a frequency lower than an operating band from a high-frequency signal transmitted through the first node; and a switch configured to connect and disconnect a path passing through the first circuit between the first node and the reference potential terminal.

### CROSS-REFERENCE TO RELATED APPLICATION

The present application is based on and claims priority to Japanese patent application No. 2025-050076, filed on Mar. 25, 2025, with the Japanese Patent Office, the entire contents of which are hereby incorporated by reference.

### TECHNICAL FIELD

The present disclosure relates to a radio frequency (RF) circuit.

### BACKGROUND

In an RF circuit, a decoupling circuit connected to an output terminal of a transistor and having a low impedance at a low frequency corresponding to an envelope band of a high-frequency signal is known (see U.S. Patent Application Publication No. 2005/0104679).

### SUMMARY

A radio frequency (RF) circuit in one embodiment of the present disclosure includes an output terminal; a first transistor including a first terminal, a second terminal, and a control terminal; a first circuit including a resistor and a first capacitor connected in series between a first node and a reference potential terminal to which a reference potential is supplied, the first node being provided between the second terminal and the output terminal, the first circuit being configured to pass, to the reference potential terminal, a signal component at a frequency lower than an operating band from a high-frequency signal transmitted through the first node; and a switch configured to connect and disconnect a path passing through the first circuit between the first node and the reference potential terminal.

A radio frequency (RF) circuit in one embodiment of the present disclosure includes a base; a transistor provided on the base; a lead electrically connected to the transistor; a switch provided on the base and including a first end electrically connected to the lead; and at least one of a resistor or a capacitor provided on the base and electrically connected to a second end of the switch.

### BRIEF DESCRIPTION OF THE DRAWINGS

FIG. 1 is a block diagram of an RF circuit according to a first embodiment.

FIG. 2 is a block diagram of the RF circuit according to a second embodiment.

FIG. 3 is a circuit diagram of the RF circuit according to a first modification of the first embodiment;

FIG. 4 is a circuit diagram of the RF circuit according to the first modification of the first embodiment;

FIG. 5 is a plan view of the RF circuit according to the first modification of the first embodiment;

FIG. 6 is a plan view of a semiconductor chip according to the first modification of the first embodiment;

FIG. 7 is a circuit diagram of the RF circuit according to a second modification of the first embodiment;

FIG. 8 is a plan view of the RF circuit according to the second modification of the first embodiment;

FIG. 9 is a circuit diagram of the RF circuit according to the first modification of the second embodiment;

FIG. 10 is a plan view of the RF circuit according to the first modification of the second embodiment.

FIG. 11 is a diagram showing S21 with respect to frequencies when a switch is turned on and off in the first modification of the second embodiment.

FIG. 12 is a circuit diagram of the RF circuit according to the second modification of the second embodiment.

FIG. 13 is a plan view of the RF circuit according to the second modification of the second embodiment.

FIG. 14 is a circuit diagram of the RF circuit according to a third modification of the second embodiment.

FIG. 15 is a plan view of the RF circuit according to the third modification of the second embodiment.

FIG. 16 is a plan view of a semiconductor chip according to the third modification of the second embodiment.

FIG. 17 is a circuit diagram of the RF circuit according to a fourth modification of the second embodiment.

FIG. 18 is a plan view of the RF circuit according to the fourth modification of the second embodiment.

FIG. 19 is a plan view of the RF circuit according to a fifth modification of the second embodiment.

FIG. 20 is a plan view of the semiconductor chip according to the fifth modification of the second embodiment.

FIG. 21 is a plan view of the RF circuit according to a sixth modification of the second embodiment.

FIG. 22 is a plan view of the RF circuit according to a seventh modification of the second embodiment.

FIG. 23 is a plan view of the semiconductor chip according to the seventh modification of the second embodiment.

FIG. 24 is a plan view of the RF circuit according to an eighth modification of the second embodiment.

### DETAILED DESCRIPTION

By providing a circuit that provides a low impedance between the output terminal of the transistor and a reference potential at frequencies lower than an operating band, effects such as distortion compensation can be achieved. On the other hand, since a portion of the high-frequency signal in the operating band leaks into the circuit, loss may occur. Therefore, although it is necessary to use a decoupling circuit for wide-band modulated wave signals from the viewpoint of distortion compensation, it is undesirable to use the decoupling circuit in a situation where communication capacity is not required, for example, for narrow-band modulated wave signals.

An object of the present disclosure is to provide an RF circuit capable of selecting cutoff and connection of a circuit for suppressing a signal at a frequency lower than an operating band.

In the present disclosure, cutoff and connection of a circuit for suppressing a signal at a frequency lower than an operating band can be selected.

### DESCRIPTION OF EMBODIMENTS OF THE PRESENT DISCLOSURE

First, embodiments of the disclosure will be described by listing them.

(1) A radio frequency (RF) circuit in one embodiment of the present disclosure includes an output terminal; a first transistor including a first terminal, a second terminal, and a control terminal; a first circuit including a resistor and a first capacitor connected in series between a first node and a reference potential terminal to which a reference potential is supplied, the first node being provided between the second terminal and the output terminal, the first circuit being configured to pass, to the reference potential terminal, a signal component at a frequency lower than an operating band from a high-frequency signal transmitted through the first node; and a switch configured to connect and disconnect a path passing through the first circuit between the first node and the reference potential terminal.

(2) In (1) above, the switch may be connected between the first circuit and the reference potential terminal. In this arrangement, it is possible to easily generate the control signal for the switch.

(3) In (1) above, the switch may be connected between the first node and the first circuit. In this arrangement, the first circuit can be separated from the first node by turning off the switch.

(4) In any one of (1) to (3) above, the RF circuit may further include an inductor connected in series with the first circuit and the switch, the inductor being between the first node and the reference potential terminal. In this arrangement, it is possible to reduce leakage, to the first circuit, of the high-frequency signal in the operating band transmitted through the first node.

(5) In (4) above, the second circuit may include an inductor connected in series with the first circuit and the switch, the inductor being between the first node and the reference potential terminal. In this arrangement, it is possible to reduce leakage, to the first circuit, of a high-frequency signal in the operating band transmitting through first node.

(6) In (4) above, the second circuit may include a second node provided between the first node and the first circuit and becoming at the reference potential at any frequency within the operating band. In this arrangement, it is possible to reduce flow, to the first circuit, of a high-frequency signal having a frequency within the operating band transmitted through the first node.

(7) In any one of (1) to (6) above, the first circuit may include a second capacitor connected in parallel with the resistor and the first capacitor, the second capacitor being between a third node and the reference potential terminal, and the third node being provided between the first node, and the resistor and the first capacitor. In this arrangement, it is possible to broaden a signal reduced by the first circuit.

(8) In any one of (1) to (7) above, the switch may be a second transistor including a third terminal, a fourth terminal, and a control terminal, and the third terminal and the fourth terminal may be provided on the path. In this arrangement, it is possible to form a switch.

(9) In any one of (1) to (8) above, an absolute value of impedance of the first capacitor at a frequency that corresponds to a width of the operating band may be 10Ω or less. In this arrangement, distortion compensation by digital predistortion (DPD) can be performed.

(10) In (8) above, the RF circuit may further include a base including at least an upper surface that is conductive, the base serving as the reference potential terminal; and a semiconductor chip mounted on the base. The second transistor and at least one of the first transistor, the resistor, or the first capacitor may be integrated on the semiconductor chip. In this arrangement, miniaturization can be achieved.

(11) A radio frequency (RF) circuit in one embodiment of the present disclosure includes a base; a transistor provided on the base; a lead electrically connected to the transistor; a switch provided on the base and including a first end electrically connected to the lead; and at least one of a resistor or a capacitor provided on the base and electrically connected to a second end of the switch. In this arrangement, selection of disconnection and connection between the lead and a circuit including at least one resistor or capacitor can be performed.

(12) In (11) above, at least an upper surface of the base may be conductive, the transistor may include a first terminal, a second terminal, and a first control terminal, the lead may be electrically connected to the second terminal of the transistor, a first end of the resistor may be electrically connected to the second end of the switch, and the capacitor may include a first electrode and a second electrode between which a dielectric substrate is interposed, the first electrode being electrically connected to the base, and the second electrode being electrically connected to a second end of the resistor. In this arrangement, selection of disconnection and connection between the lead and a circuit including a resistor and capacitor can be performed.

### DETAILS OF EMBODIMENTS OF PRESENT DISCLOSURE

Specific examples of RF circuits according to embodiments of the present disclosure will be described below with reference to the drawings. The present disclosure is not limited to these examples, and is intended to be presented by the claims and to include all modifications within the meaning and scope of the claims.

### First Embodiment

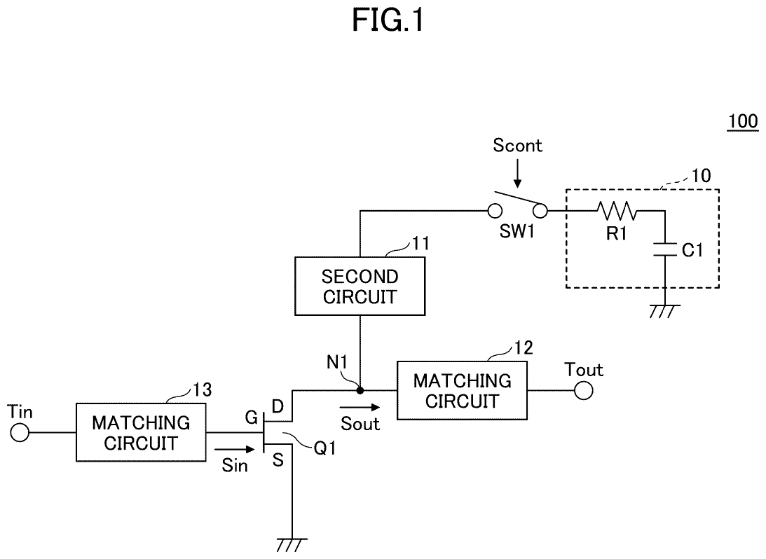

In the following embodiments, an RF amplifier circuit will be described as the RF circuit. In a first embodiment, a switch is connected between a first circuit 10 and a second circuit 11. FIG. 1 is a block diagram of the RF circuit according to the first embodiment. As shown in FIG. 1, an RF circuit 100 according to the first embodiment includes a transistor Q1, the first circuit 10, the second circuit 11, and matching circuits 12 and 13.

The transistor Q1 (first transistor) is, for example, a field effect transistor (FET), and has a source S (first terminal), a drain D (second terminal), and a gate G (control terminal). The source S is electrically connected to a reference potential terminal such as a ground terminal and is short-circuited. The gate G is electrically connected to an input terminal Tin via the matching circuit 13. The drain D is electrically connected to an output terminal Tout via the matching circuit 12. A node N1 (first node) provided between the drain D and the output terminal Tout is electrically connected to the reference potential terminal via the second circuit 11 and the first circuit 10.

The transistor Q1 is, for example, a GaN gallium nitride high electron mobility transistor (HEMT) or a laterally diffused metal oxide semiconductor (LDMOS).

The matching circuit 13 matches the impedance as seen from the input terminal Tin toward the matching circuit 13 with the impedance as seen from the matching circuit 13 toward the gate G of the transistor Q1. The transistor Q1 amplifies a high-frequency signal Sin input to the input terminal Tin and outputs an amplified high-frequency signal Sout to the drain D. The matching circuit 12 matches the impedance as seen from the drain D of the transistor Q1 toward the matching circuit 12 and the impedance as seen from the matching circuit 12 toward the output terminal Tout.

The first circuit 10 has a resistor R1 and a capacitor C1 (first capacitor) connected in series between the node N1 and the reference potential terminal. The first circuit 10 passes, to the reference potential terminal, signal components at frequencies lower than the operating band of the RF circuit 100 from the high-frequency signal Sout that flows through the node N1. The order of the capacitor C1 and the resistor R1 may be reversed. That is, the resistor R1 may be provided between the capacitor C1 and the reference potential terminal. The resistor R1 is a damping resistor for reducing resonance between the capacitor C1 having a large capacitance and an inductor (for example, an inductor formed by a bonding wire described later).

The second circuit 11 reduces flow of signal components having frequencies within the operating band from the high-frequency signal Sout transmitted through the node N1 into the first circuit 10. When the RF circuit 100 is used as a power amplifier for a mobile communication base station, the center frequency of the operating band is, for example, higher than or equal to 0.5 GHz and less than or equal to 20 GHz, and the width of the operating band is, for example, higher than or equal to 0.1 MHz and less than or equal to 1 GHz.

A switch SW1 is connected between the second circuit 11 and the first circuit 10. The switch SW1 connects and disconnects a path passing through the first circuit 10 between the node N1 and the reference potential terminal based on a control signal Scont.

A drain bias voltage applied to the drain D of the transistor Q1 is supplied from either between the second circuit 11 and the switch SW1 or between the drain D and the output terminal Tout.

### Second Embodiment

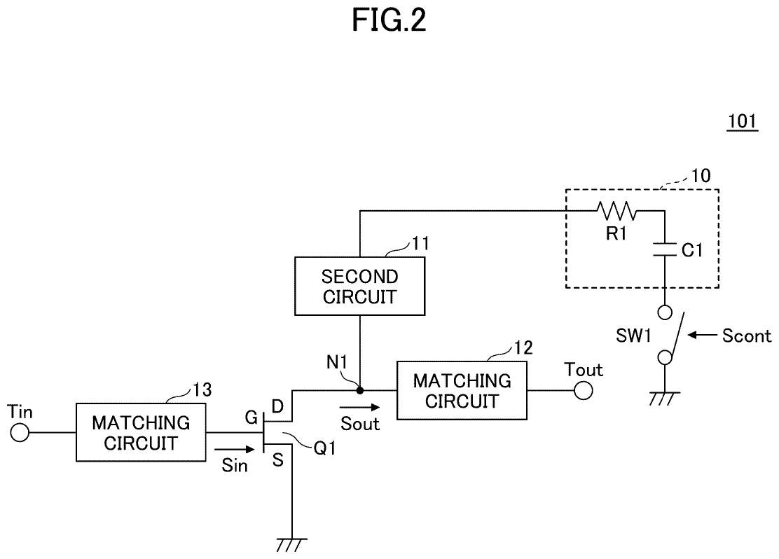

In a second embodiment, the switch SW1 is connected between the first circuit 10 and the reference potential terminal. FIG. 2 is a block diagram of the RF circuit according to the second embodiment. As shown in FIG. 2, in an RF circuit 101 according to the second embodiment, the switch SW1 is connected between the first circuit 10 and the reference potential terminal. Other configurations are the same as those of the first embodiment, and description thereof is omitted.

In the first embodiment and the second embodiment, the first circuit 10 is, for example, a video bandwidth (VBW) circuit, which is a circuit for improving the video bandwidth. The VBW is used as an index representing a band of intermodulation distortion. When the VBW is small, measurement of third-order intermodulation distortion (IMD3: 3rd order Intermodulation Distortion) of a two-tone signal corresponding to the bandwidth of the RF circuit 100 shows a difference in signal strength between an IMD3 component on the low-frequency side and an IMD3 component on the high-frequency side. When such asymmetry occurs in the IMD3, even if distortion compensation is performed by digital predistortion (DPD), an amount of distortion improvement decreases and sufficient distortion characteristics cannot be obtained. As a cause of the asymmetry of the IMD3, a secondary intermodulation distortion IMD2 component generated in the difference frequency component of the two-tone signal is known. Therefore, by providing the first circuit 10, the video bandwidth is increased and the IMD2 component is suppressed. As a result, the asymmetry of the IMD3 is improved and sufficient distortion compensation can be performed by DPD.

When the bandwidths of the high frequency signals Sin and Sout are large, distortion compensation can be made more effective by providing the VBW circuit. When the bandwidths of the high frequency signals Sin and Sout are small, even if the VBW is small, a problem is less likely to occur, and the VBW circuit does not need to be used. As described above, there are cases where characteristics can be improved by providing the first circuit 10 such as the VBW circuit, and cases where the first circuit 10 need not be provided.

By providing the second circuit 11 between the node N1 and the first circuit 10, it is possible to reduce an increase in loss caused by leakage, to the first circuit 10, of signal components at frequencies within the operating band from the high frequency signal Sout flowing through the node N1. However, in practice, a portion of the signal components at frequencies within the operating band flows into the resistor R1, and power is consumed by heat generation in the resistor R1, resulting in loss in the RF circuits 100 and 101.

As described above, when characteristics can be improved by providing the first circuit 10, it is desirable to provide the first circuit 10. On the other hand, when characteristics are not significantly improved even by using the first circuit 10, it is desirable not to provide the first circuit 10.

When the RF circuits 100 and 101 are amplifier circuits, the operating band is a frequency range of frequencies at which the absolute value of S21 is −3 dB below a maximum value of the absolute value of S21 when the input terminal Tin is port 1 and the output terminal Tout is port 2. The operating band does not change with different applications of the RF circuits 100 and 101. The bandwidth of the high-frequency signal Sin is the bandwidth of a signal input to the input terminal Tin and differs depending on the applications of the RF circuits 100 and 101. The bandwidth of the high-frequency signal is equal to or smaller than the operating band.

In the first embodiment and the second embodiment, the switch SW1 is provided between the node N1 and the reference potential terminal for connecting and disconnecting a path passing through the first circuit 10. Thus, when the switch SW1 is turned on, the first circuit 10 is connected between the node N1 and the reference potential terminal. As a result, signal components at frequencies lower than the operating band in the high-frequency signal Sout transmitted through the node N1 can flow to the reference potential terminal. Thus, for example, VBW can be increased, and distortion compensation can be made more effective. When the switch SW1 is turned off, the first circuit 10 is disconnected from between the node N1 and the reference potential terminal. In this arrangement, this reduces consumption of a portion of the signal components in the operating band of the high-frequency signal Sout transmitted through the node N1 by the resistor R1 of the first circuit 10, and loss in the RF circuits 100 and 101 is increased. Thus, the switch SW1 can be turned on or off depending on the application in which the RF circuits 100 and 101 are used.

As in the RF circuit 100 of the first embodiment, the switch SW1 may be connected between the node N1 and the first circuit 10. Thus, by turning off the switch SW1, the second circuit 11 and the first circuit 10 can be completely separated.

As in the RF circuit 101 of the second embodiment, the switch SW1 may be connected between the first circuit 10 and the reference potential terminal. This makes it easy to generate the voltage of the control signal for the switch SW1 as described later.

As in the first embodiment and the second embodiment, the second circuit 11 reduces flow, to the first circuit 10, of signal components of the high-frequency signal Sout at frequencies within the operating band. This makes it possible to reduce leakage of the high-frequency signal within the operating band from the node N1 to the first circuit 10. Therefore, loss in the RF circuits 100 and 101 can be reduced.

### First Modification of First Embodiment

In a first modification of the first embodiment, the switch SW1 is connected between the first circuit 10 and the second circuit 11, and a low-pass matching circuit is used as the matching circuit 12.

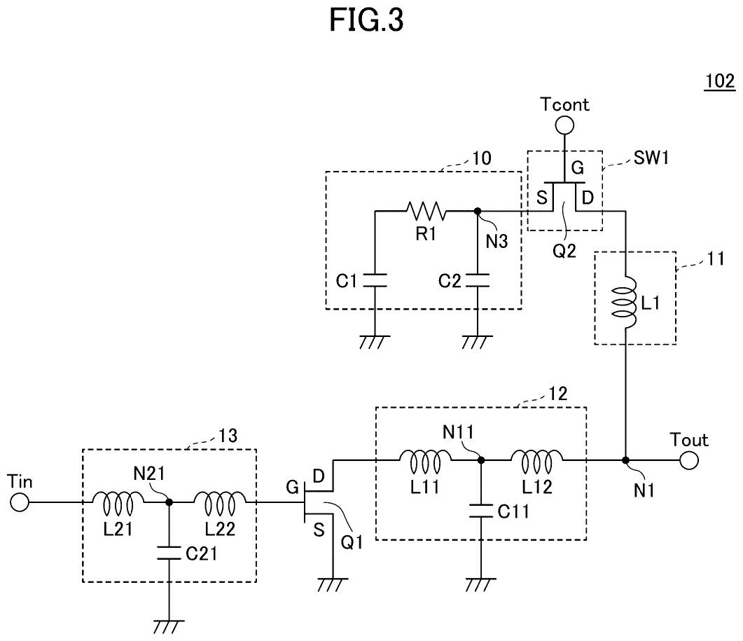

FIG. 3 is a circuit diagram of the RF circuit according to the first modification of the first embodiment. As shown in FIG. 3, the first circuit 10 includes capacitors C1 and C2 and a resistor R1. The capacitor C2 is connected in shunt to a node N3 between the resistor R1 and the transistor Q2.

The switch SW1 has a transistor Q2 (second transistor). The transistor Q2 is, for example, a field effect transistor (FET). The transistor Q2 may be a transistor other than the FET, such as a bipolar transistor. A source S (third terminal) of the transistor Q2 is electrically connected to the first circuit 10, and a drain D (fourth terminal) of the transistor Q2 is electrically connected to the second circuit 11. A gate G (control terminal) of the transistor Q2 is electrically connected to a control signal terminal Tcont. A control signal (control signal Scont in FIG. 1) for turning on or off the transistor Q2 is input to the control signal terminal Tcont.

The second circuit 11 has an inductor L1. A first end of the inductor L1 is electrically connected to the node N1, and a second end of the inductor L1 is electrically connected to the drain D of the transistor Q2. The inductor L1 has a high impedance in the operating band.

The matching circuit 12 is a low-pass T-type LCL circuit, for example, and has inductors L11 and L12 and a capacitor C11. The inductors L11 and L12 are connected in series between the drain D of the transistor Q1 and the output terminal Tout. The capacitor C11 is connected in shunt to the node N11 between the inductors L11 and L12.

The matching circuit 13 is, for example, a T-type LCL circuit and has inductors L21 and L22 and a capacitor C21. The inductors L21 and L22 are connected in series between the input terminal Tin and the gate G of the transistor Q1. The capacitor C21 is connected in shunt to a node N21 between the inductors L21 and L22. Other configurations are the same as those in FIG. 1 of the first embodiment, and description thereof is omitted.

In the first modification of the first embodiment, the first circuit 10 has a node N3 (third node) and a capacitor C2 (second capacitor). The node N3 is a node provided between the resistor R1 and the capacitor C1, and the second circuit 11. The capacitor C2 is connected in parallel with the resistor R1 and the capacitor C1 between the node N3 and the reference potential terminal. By making the capacitances of the capacitors C1 and C2 different from each other, the bandwidth of signal components reduced by the first circuit 10 in the high-frequency signal Sout can be widened. The capacitance of the capacitor C2 can be 1/10 or less or 10 times or more of the capacitance of the capacitor C1, and can be 1/100 or less or 100 times or more of the capacitance of the capacitor C1.

### Specific Example of First Modification of First Embodiment

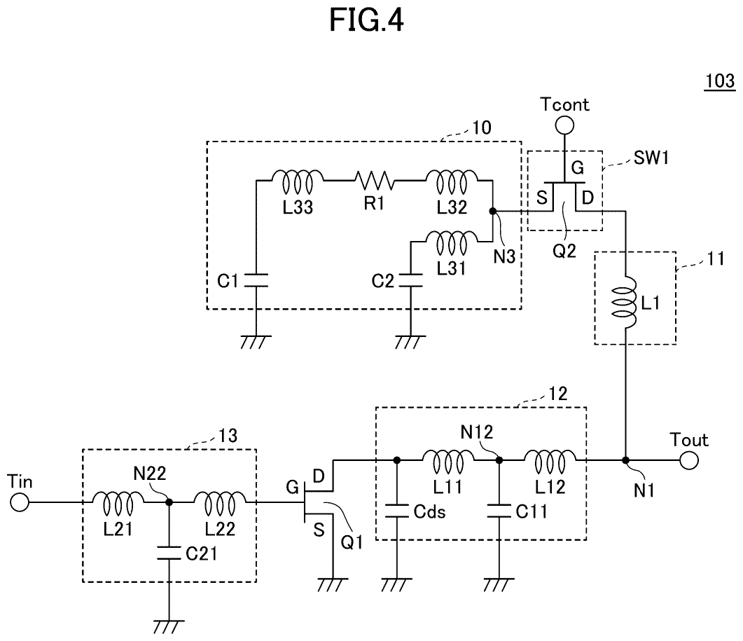

A specific example of the first modification of the first embodiment is an example in which the RF circuit is provided in a package 15 in the first embodiment. FIG. 4 is a circuit diagram of the RF circuit according to the first modification of the first embodiment. As shown in FIG. 4, the first circuit 10 includes inductors L31, L32, and L33. The inductor L31 is connected between the node N3 and the capacitor C2. The inductor L32 is connected between the node N3 and a resistor R1. The inductor L33 is connected between the resistor R1 and the capacitor C1. A drain-source capacitance Cds is connected in shunt to the drain D of the transistor Q1. The drain-source capacitance Cds corresponds to the source-drain parasitic capacitance of the transistor Q1 and is an internal capacitance of the transistor Q1, and functions as part of the low-pass matching circuit 12. Other circuit configurations are the same as those in FIG. 3, and description thereof is omitted.

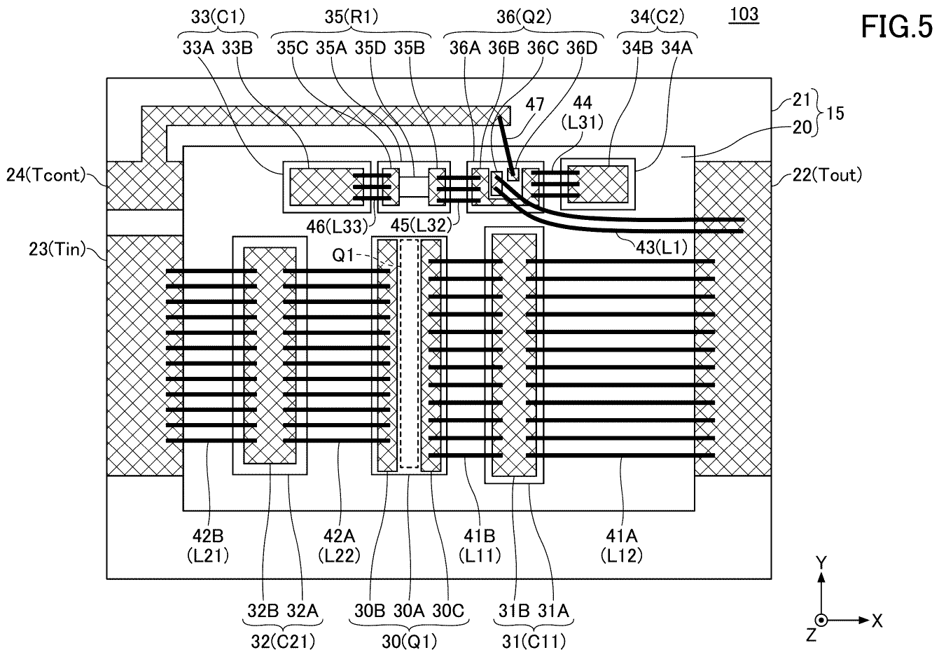

FIG. 5 is a plan view of the RF circuit according to the first modification of the first embodiment. A thickness direction of a base 20 is the Z direction, a direction from the input terminal 23 to the output terminal 22 in a frame 21 is the X direction, and the direction orthogonal to the X direction and the Z direction is the Y direction.

As shown in FIG. 5, an RF circuit 103 according to the first modification of the first embodiment includes the package 15, semiconductor chips 30 and 36, capacitive components 31, 32, 33, and 34, and a resistive component 35.

The package 15 includes the base 20, the frame 21, and a lid (not shown). At least a +Z surface of the base 20 is a conductor. The base 20 may be, for example, a metal plate in which a copper layer, a molybdenum layer, and a copper layer are laminated. The base 20 functions as the reference potential terminal to which a reference potential such as a ground potential is supplied.

The semiconductor chips 30 and 36, the capacitive components 31, 32, 33, and 34, and the resistive component 35 are mounted on the base 20 with, for example, a conductive bonding layer between the above components and the base 20. The frame 21 is provided on the base 20 so as to surround the semiconductor chips 30 and 36, the capacitive components 31, 32, 33, and 34, and the resistive component 35. The frame 21 is an insulating layer made of, for example, a ceramic or resin. The input terminal 23, the output terminal 22, and the control signal terminal 24 are provided on the frame 21. The input terminal 23, the output terminal 22, and the control signal terminal 24 are for example, metal layers such as a copper layer or a gold layer. The input terminal 23, the output terminal 22, and the control signal terminal 24 correspond to the input terminal Tin, the output terminal Tout, and the control signal terminal Tcont, respectively.

The semiconductor chip 30 has a semiconductor substrate 30A, electrodes 30B and 30C provided on the upper surface of the semiconductor substrate 30A, an electrode (not shown) provided on the lower surface of the semiconductor substrate 30A, and the transistor Q1. Electrodes 30B and 30C, and an electrode on the lower surface of the semiconductor substrate 30A are a gate electrode, a drain electrode, and a source electrode, respectively, and are electrically connected to the gate G, the drain D, and the source S of the transistor Q1, respectively. When the transistor Q1 is a GaN HEMT, the semiconductor substrate 30A is, for example, a silicon carbide substrate or a sapphire substrate. When the transistor Q1 is the LDMOS, the semiconductor substrate 30A is, for example, a silicon substrate. The electrodes 30B and 30C are metal layers such as a gold layer or a copper layer.

The capacitive components 31, 32, 33, and 34 have respective dielectric substrates 31A, 32A, 33A, and 34A, respective electrodes 31B, 32B, 33B, and 34B, and respective electrodes under these dielectric substrates 31A, 32A, 33A, and 34A. The dielectric substrates 31A, 32A, 33A, and 34A are, for example, alumina substrates or barium titanate substrates. The electrodes 31B, 32B, 33B, and 34B are metal layers such as, a gold layer or a copper layer. The dielectric substrate 31A, the electrode 31B, and the electrode under the dielectric substrate 31A correspond to a capacitor C11, with the dielectric substrate 31A that is interposed between the electrode 31B and the electrode under the dielectric substrate 31A. The dielectric substrate 32A, the electrode 32B, and the electrode under the dielectric substrate 32B correspond to a capacitor C21, with the dielectric substrate 32A that is interposed between the electrode 32B and the electrode under the dielectric substrate 32B. The dielectric substrate 33A, the electrode 33B, and the electrode under the dielectric substrate 33A correspond to a capacitor C1, with the dielectric substrate 33A that is interposed between the electrode 33B and the electrode under the dielectric substrate 33A. The dielectric substrate 34A, the electrode 34B, and the electrode under the dielectric substrate 34A correspond to the capacitor C2.

The resistive component 35 has a substrate 35A, electrodes 35B and 35C, and a resistor 35D. The substrate 35A is, for example, an insulating substrate such as an alumina substrate, or a semiconductor substrate such as a silicon substrate. The electrodes 35B and 35C are metal layers such as a gold layer or a copper layer. The resistor 35D is, for example, a tantalum nitride film. The resistor 35D constitutes part of the resistor R1.

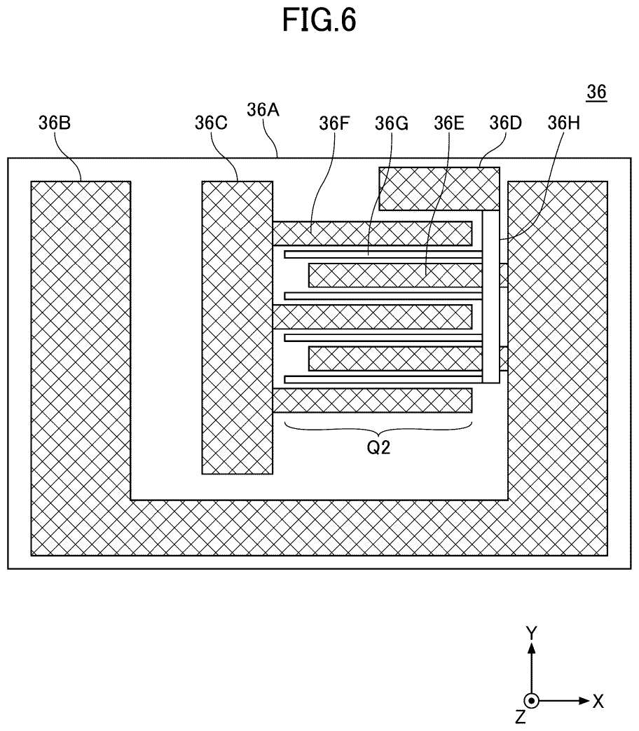

FIG. 6 is a plan view of a semiconductor chip in the first modification of the first embodiment. As shown in FIG. 6, a semiconductor chip 36 has a semiconductor substrate 36A, electrodes 36B, 36C, and 36D, and the transistor Q2. The electrodes 36B, 36C, and 36D and the transistor Q2 are provided on the semiconductor substrate 36A. The transistor Q2 has source electrodes 36E, drain electrodes 36F, and gate electrodes 36G. The source electrodes 36E and the drain electrodes 36F are alternately provided. One gate electrode 36G is provided between one source electrode 36E and one drain electrode 36F. The source electrodes 36E are electrically connected to the electrode 36B in common, the drain electrodes 36F are electrically connected to the electrode 36C in common, and the gate electrodes 36G are electrically connected to the electrode 36D in common. The transistor Q2 is, for example, a nitride semiconductor transistor such as a GaN HEMT, an arsenide semiconductor transistor, or a silicon transistor.

Referring back to FIG. 5, each bonding wire 41A electrically connects the output terminal Tout and the electrode 31B, and each bonding wire 41B electrically connects the electrodes 31B and 30C. Each bonding wire 42A electrically connects the electrodes 30B and 32B, and each bonding wire 42B electrically connects the electrode 32B and the input terminal 23. Each bonding wire 43 electrically connects the output terminal 22 and the electrode 36C, each bonding wire 44 electrically connects the electrode 36B and the electrode 34B, and each bonding wire 45 electrically connects the electrodes 36B and 35B. Each bonding wire 46 electrically connects the electrodes 35C and 33B. Each bonding wire 47 electrically connects the electrodes 36D and the control signal terminal 24. The bonding wires 41A, 41B, 42A, 42B, 43, 44, 45, 46, and 47 are, for example, metal thin wires such as gold wires or aluminum wires. The bonding wires 41A, 41B, 42A, 42B, 43, 44, 45, and 46 correspond to the inductors L12, L11, L22, L21, L1, L31, L32, and L33, respectively.

Table 1 shows examples of the capacitances of the capacitors C1 and C2 and the resistance of the resistor R1 in the first circuit 10.

TABLE 1

| C1 | R1 | C2 |
|---|---|---|
| 0.1 nF~10 nF | 0.5 Ω~10 Ω | 0.5 μF~10 μF |

Table 2 shows an example of the inductance of the inductor L1 in the second circuit 11.

TABLE 2
L1
0.1 nH~5.0 nH

Table 3 shows examples of the inductances of the inductors L31, and L32, and L33 and the capacitance of the drain-source capacitance Cds.

TABLE 3

| L31, L32, L33 | Cds |
|---|---|
| 0.05 nH~0.5 nH | 0.1 pF~50 pF |

Table 4 shows examples of the inductances of the inductors L11 and L12 and the capacitance of the capacitor C11 in the matching circuit 12.

TABLE 4

| L11 | C11 | L12 |
|---|---|---|
| 0.05 nH~2.0 nH | 1 pF~50 pF | 0.05 nH~0.5 nH |

Table 5 shows examples of the inductances of the inductors L21 and L22 of the matching circuit 13 and the capacitance of the capacitor C21.

TABLE 5

| L21 | C21 | L22 |
|---|---|---|
| 0.05 nH~2.0 nH | 1 pF~100 pF | 0.05 nH~2.0 nH |

### Second Modification of First Embodiment

In a second modification of the first embodiment, the switch SW1 is connected between the first circuit 10 and the second circuit 11, and a high-pass matching circuit is used as the matching circuit 12.

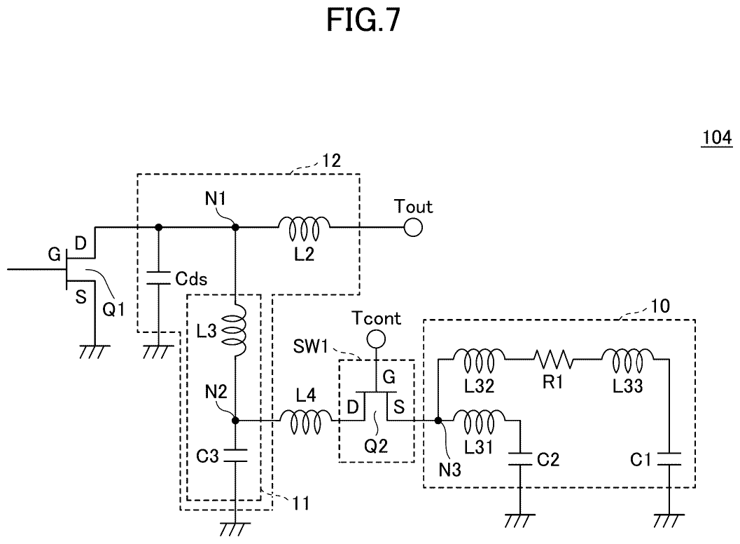

FIG. 7 is a circuit diagram of the RF circuit according to the second modification of the first embodiment. The matching circuit 13 is not shown. As shown in FIG. 7, in an RF circuit 104 according to the second modification of the first embodiment, the second circuit 11 includes an inductor L3 and a capacitor C3. The inductor L3 electrically connects the nodes N1 and N2, and the capacitor C3 electrically connects the node N2 and the reference potential terminal. The inductor L2 electrically connects the node N1 and the output terminal Tout. The inductor L4 electrically connects the node N2 and the drain D of the transistor Q2. The second circuit 11, the inductor L2, and the drain-source capacitor Cds function as the high-pass matching circuit 12. Other configurations are the same as those in FIG. 4 of the first modification of the first embodiment, and description thereof is omitted.

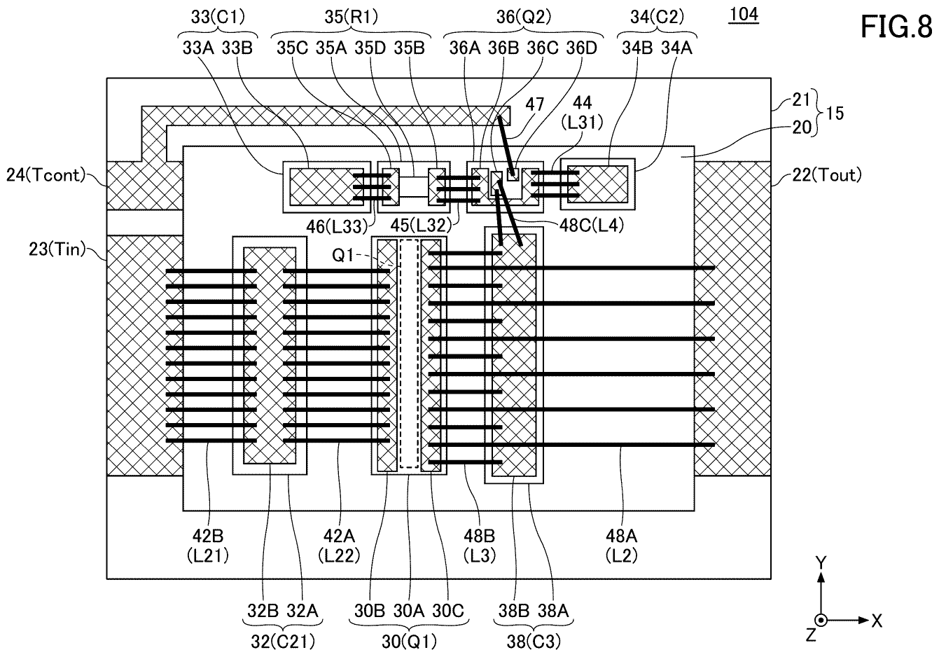

FIG. 8 is a plan view of the RF circuit according to the second modification of the first embodiment. As shown in FIG. 8, in an RF circuit 104 according to the second modification of the first embodiment, a capacitive component 38 is provided instead of the capacitive component 31. The capacitive component 38 has a dielectric substrate 38A, an electrode 38B provided on the dielectric substrate 38A, and an electrode under the dielectric substrate 38A. The materials of the dielectric substrate 38A and the electrode 38B are the same as those of the capacitive component 31. The dielectric substrate 38A, the electrode 38B, and an electrode under the dielectric substrate 38A correspond to a capacitor C3, with the dielectric substrate 38A that is interposed between the electrode 38B and the electrode under the dielectric substrate 38A.

Bonding wires 48A and 48B are provided instead of the bonding wires 41A and 41B. Each bonding wire 48A electrically connects the electrode 30C and the output terminal Tout. Each bonding wire 48B electrically connects the electrodes 30C and 38B. Each bonding wire 48C is provided instead of the bonding wire 43. The bonding wire 48C electrically connects the electrodes 38B and 36C. The bonding wires 48A, 48B, and 48C correspond to the inductors L2, L3, and L4, respectively. Other configurations are the same as those in FIG. 5 of the first modification of the first embodiment, and description thereof is omitted.

Table 6 shows examples of the inductances of the inductors L2, L3, and L4 and the capacitance of the capacitor C3 in the second modification of the first embodiment. Examples of the inductances, capacitances, and resistances other than those in Table 6 are the same as those in Tables 1 and 3 to 5. Other configurations are the same as those in the first modification of the first embodiment, and description thereof is omitted.

TABLE 6

| L2 | L3 | L4 | C3 |
|---|---|---|---|
| 0.05 nH~0.5 nH | 0.05 nH~3.0 nH | 0.05 nH~0.5 nH | 10 pF~200 pF |

### First Modification of Second Embodiment

In a first modification of the second embodiment, the switch SW1 is connected between the first circuit 10 and the reference potential terminal, and a low-pass matching circuit is used as the matching circuit 12.

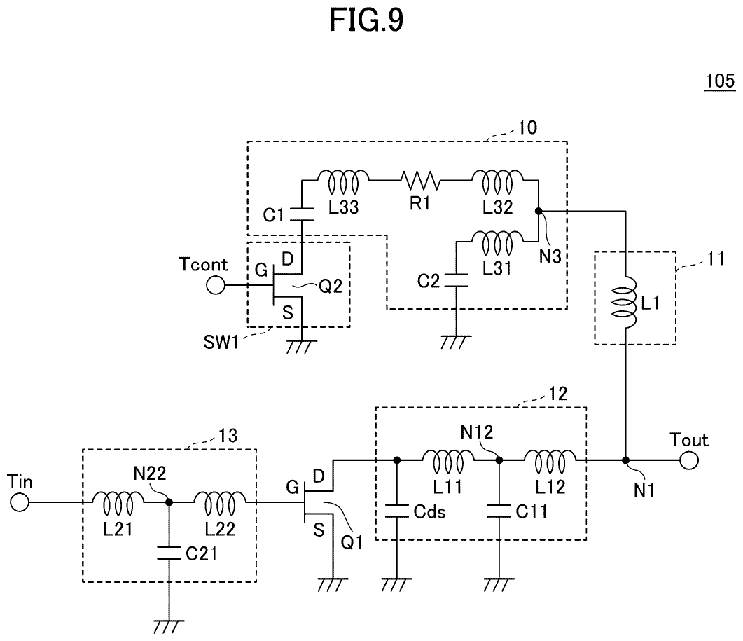

FIG. 9 is a circuit diagram of the RF circuit according to the first modification of the second embodiment. As shown in FIG. 9, in an RF circuit 105 according to the first modification of the second embodiment, the transistor Q2 is connected between the reference potential terminal and the first circuit 10. The source S and the drain D of the transistor Q2 are electrically connected to the reference potential terminal and the first circuit 10, respectively. Other configurations are the same as those in FIG. 4 of the first modification of the first embodiment, and description thereof is omitted.

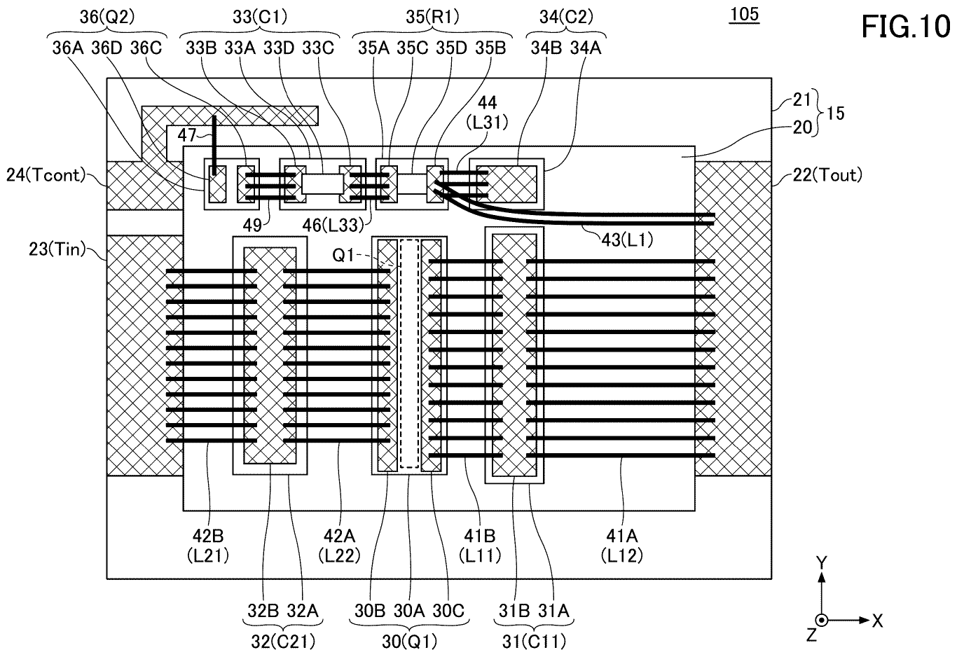

FIG. 10 is a plan view of the RF circuit according to the first modification of the second embodiment. As shown in FIG. 10, in an RF circuit 105 according to the first modification of the second embodiment, bonding wires 43 and 44 are electrically connected to the electrode 35B of the resistive component 35.

The capacitive component 33 has a dielectric substrate 33A, electrodes 33B and 33C, and a discrete chip capacitor 33D. The electrodes 33B and 33C are provided on the dielectric substrate 33A. The chip capacitor 33D is mounted on the electrodes 33B and 33C. The chip capacitor 33D corresponds to the capacitor C1.

A semiconductor chip 36 has electrodes 36C and 36D and an electrode (not shown) provided under the semiconductor substrate 36A. The electrodes 36C and 36D and the electrode under the semiconductor substrate 36A are electrically connected to the drain D, the gate G, and the source S of the transistor Q2, respectively.

Examples of inductances, capacitances, and resistances are the same as those in Tables 1 to 5. Other configurations are the same as those in the first modification of the first embodiment, and description thereof is omitted.

### Simulation

In the first modification of the second embodiment, transmission characteristics of the first circuit 10 are simulated by turning on and off the transistor Q2. Table 7 shows the capacitances of the capacitors C1 and C2, the resistance of the resistor R1, and the voltage of the transistor Q2. Vgs (ON) indicates the gate-source voltage of the transistor Q2 when the switch SW1 is turned on. Vgs (OFF) indicates the gate-source voltage of the transistor Q2 when the switch SW1 is turned off.

TABLE 7

| C1 | R1 | C2 | L31, L32, L33 | Vgs (ON) | Vgs (OFF) |
|---|---|---|---|---|---|
| 4.7 nF | 3 Ω | 1 μF | 1 nH | +3 V | −3 V |

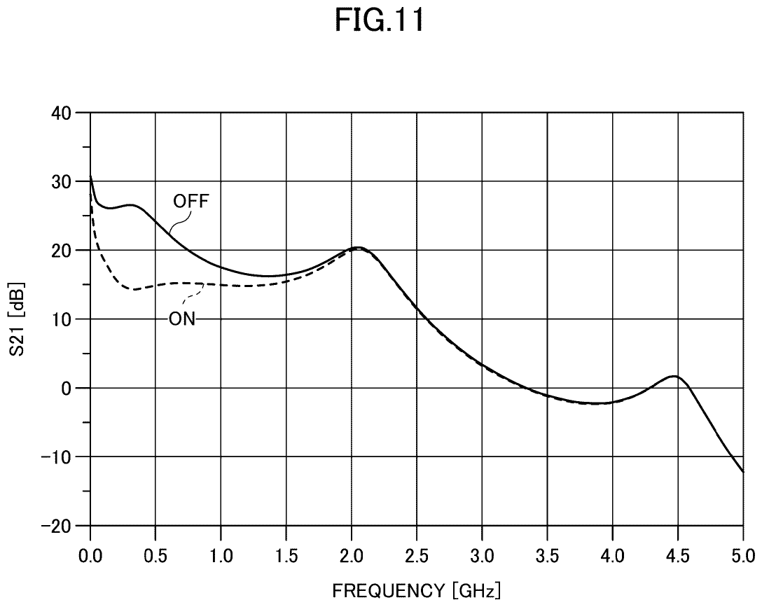

FIG. 11 is a diagram showing S21 with respect to frequency when the switch is turned on and off in the first modification of the second embodiment. The vertical axis represents the absolute value of S21 when the end of the first circuit 10 on the inductor L1 side is port 1 and the reference potential terminal is port 2. As shown in FIG. 11, when the switch SW1 is turned on, S21 at frequencies of 1 GHz or less decreases compared with when the switch SW1 is turned off. Thus, it can be seen that when the switch SW1 is turned on, the first circuit 10 passes low-frequency signals (in particular, signals at 500 MHz or less, which corresponds to the width of the operating band).

### Second Modification of Second Embodiment

A second modification of the second embodiment is an example in which the switch SW1 is connected between the first circuit 10 and the reference potential terminal, and a high-pass matching circuit is used as the matching circuit 12.

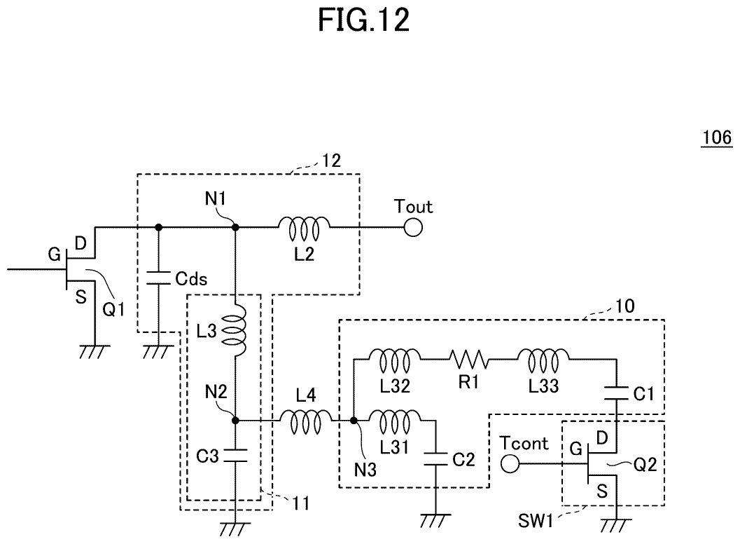

FIG. 12 is a circuit diagram of the RF circuit according to the second modification of the second embodiment. As shown in FIG. 12, in an RF circuit 106 according to the second modification of the second embodiment, the transistor Q2 is connected between the reference potential terminal and the first circuit 10. The source S and the drain D of the transistor Q2 are electrically connected to the reference potential terminal and the first circuit 10, respectively. Other configurations are the same as those in FIG. 7 of the second modification of the first embodiment, and description thereof is omitted.

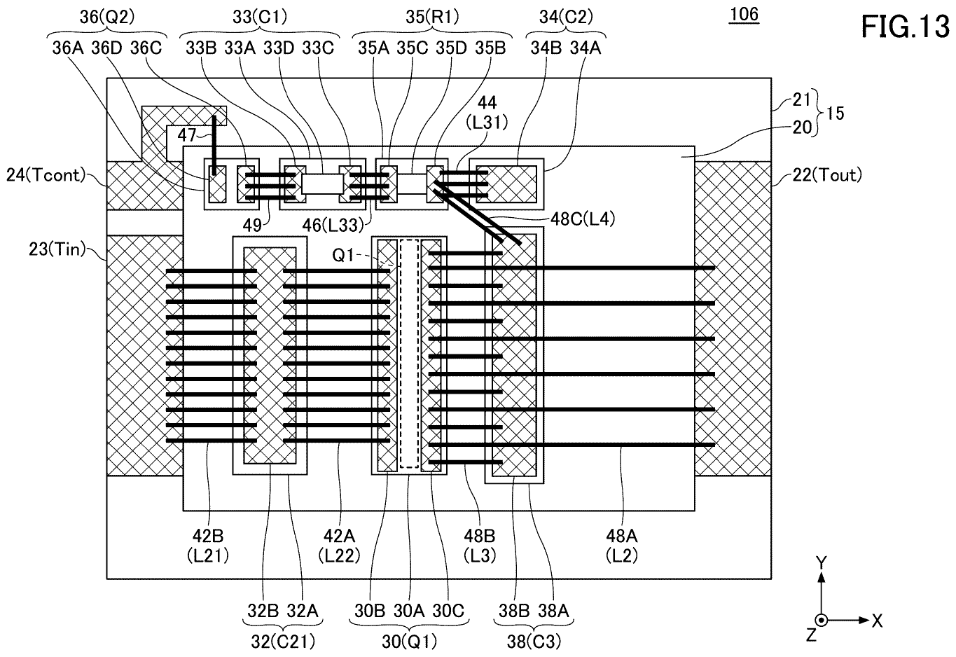

FIG. 13 is a plan view of the RF circuit according to the second modification of the second embodiment. As shown in FIG. 13, in an RF circuit 106 according to the second modification of the second embodiment, the bonding wires 48C and 44 are electrically connected to the electrode 35B of the resistive component 35. The capacitive component 33 and the semiconductor chip 36 have the same configuration as the capacitive component 33 and the semiconductor chip 36 in FIG. 10 of the first modification of the second embodiment. Examples of inductances, capacitances, and resistances are the same as those in Tables 1 and 3 to 6 of the first modification of the first embodiment. Other configurations are the same as those in the second modification of the first embodiment, and description thereof is omitted.

### First Modification and Second Modification of First Embodiment and Second Embodiment

In the first modification of the first embodiment and the first modification of the second embodiment, the matching circuit 12 is of a low-pass type. In this case, the second circuit 11 has an inductor L1 connected in series with the first circuit 10 and the switch SW1 between the node N1 and the reference potential terminal. A control signal for turning on the transistor Q2 is applied to the control signal terminal Tcont to turn on the switch SW1. At this time, the inductor L1 has a high impedance in the operating band (e.g., 1 GHz or higher). This reduces flow, to the first circuit 10, of the high-frequency signal Sout in the operating band flowing through the node N1. On the other hand, the capacitor C1 allows the low-frequency signal flowing through the node N1 to pass through the inductor L1 and the first circuit 10 to the reference potential terminal. Thus, low-frequency signals transmitted through the node N1 can be reduced, and leakage of the high-frequency signals within the operating band transmitted through the node N1 into the first circuit 10 can be reduced, thereby reducing loss in the RF circuit.

Let the center frequency of the operating band be f0, and the frequency corresponding to the width of the operating band be Δf. Let the inductance of the inductor L1 be L1, and the capacitance of the capacitor C1 be C1. In this case, the absolute value ZL of the impedance of the inductor L1 at the center frequency f0 is (2π·f0·L1). The absolute value ZC of the impedance of the capacitor C1 at the frequency Δf is (1/(2π·Δf·C1)). Since the inductor L1 does not pass the high-frequency signal in the operating band and the first circuit 10 passes the signal of the frequency Δf, ZL is greater than ZC. ZL may be 10 dB or more greater than ZC, or may be 20 dB or more.

In the second modification of the first embodiment and the second modification of the second embodiment, a high-pass matching circuit 12 is used. In the matching circuit 12, the node N1 becomes the reference potential such as a ground potential at any frequency in the operating band. In this arrangement, the switch SW1 and the first circuit 10 are connected between the node N2 and the reference potential terminal. That is, the second circuit 11 has a node N2 (second node) that is provided between the node N1 and the first circuit 10, and becomes a reference potential at any frequency in the operating band. Thus, it is possible to reduce flow, to the first circuit 10, of high-frequency signal components at frequencies in the operating band transmitted through the node N1.

The node N2 may become the reference potential at the center frequency f0 of the operating band. This makes it possible to reduce leakage of the signal at the center frequency f0 to the reference potential terminal via the first circuit 10.

In the first modification and the second modification of the first embodiment, the bias voltage at the node N1 is the drain bias voltage. When the RF circuits 103 and 104 are high-output amplifier circuits, the drain bias voltage is, for example, 50 V or higher. In order to turn on and off the transistor Q2, the gate voltage is set to a voltage near a threshold voltage with respect to the source voltage. In this arrangement, the control signal supplied to the control signal terminal Tcont is around 50 V. When the drain bias voltage is used to generate the control signal, the on/off state of the transistor Q2 affects the drain bias voltage.

On the other hand, in the first modification and the second modification of the second embodiment, the transistor Q2 is DC-isolated from the node N1 by the capacitor C1. Therefore, a voltage for turning on and off the transistor Q2 may be applied to the control signal terminal Tcont as a control signal without being affected by the drain bias voltage. The voltage of the control signal may range from −10 V to +10 V, for example. Further, it is possible to reduce the influence of the on/off state of the transistor Q2 on the drain bias voltage.

In the first modification and the second modification of each of the first embodiment and the second embodiment, the absolute value ZC of the impedance at a frequency Δf corresponding to the width of the operating band of the capacitor C1 may be 10Ω or less, 5Ω or less, or 1Ω or less. It is possible to reduce the signal at the frequency Δf flowing through the node N1. Thus, distortion compensation by DPD can be performed.

### Third Modification of Second Embodiment

In a third modification of the second embodiment, the switch SW1 is connected between the first circuit 10 and the reference potential terminal, a low-pass matching circuit is used as the matching circuit 12, and the transistor Q2 and the resistor R1 are provided on the same semiconductor chip.

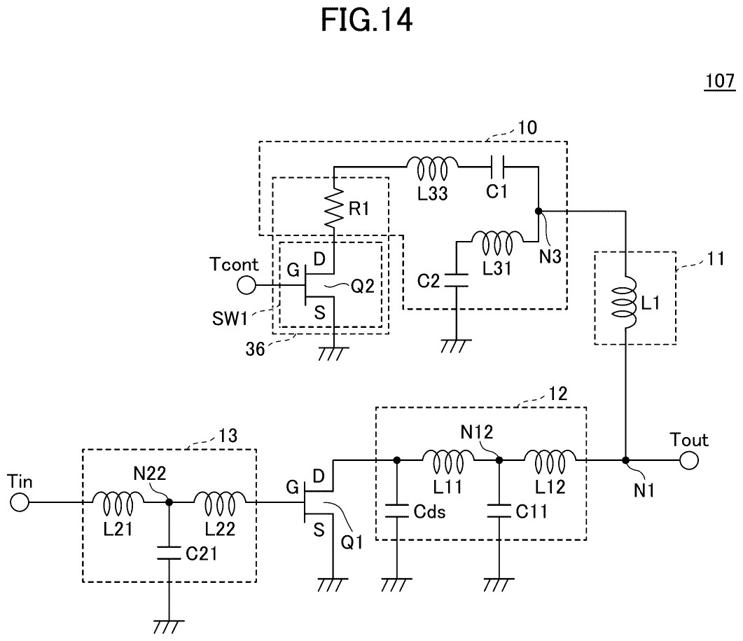

FIG. 14 is a circuit diagram of the RF circuit according to the third modification of the second embodiment. As shown in FIG. 14, in an RF circuit 107 according to the third modification of the second embodiment, a capacitor C1, an inductor L33, and a resistor R1 are connected in series in this order from the node N3 between the node N3 and the drain D of the transistor Q2. The transistor Q2 and the resistor R1 are formed on the semiconductor chip 36.

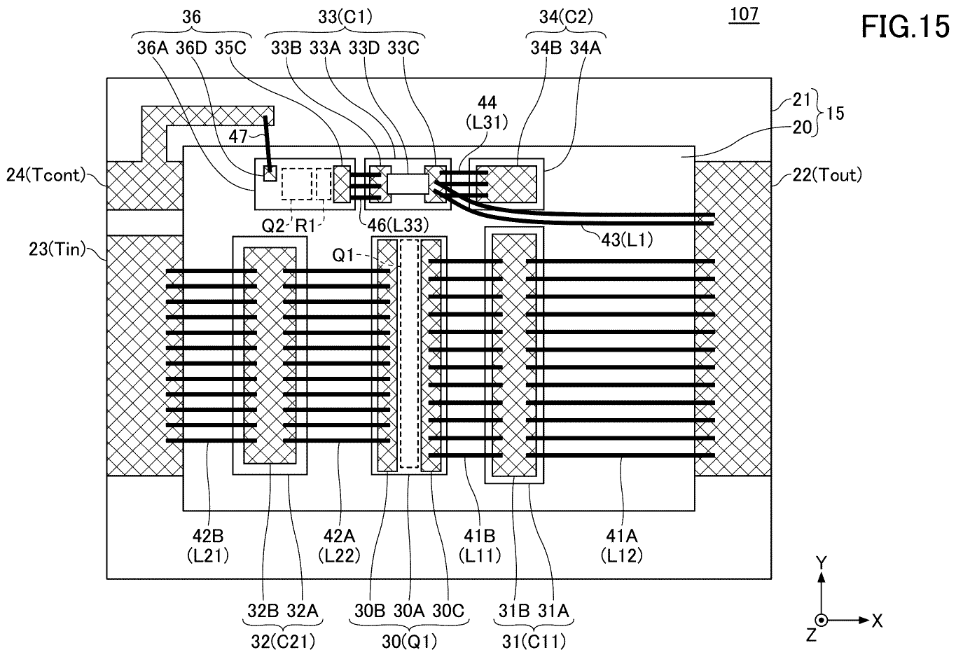

FIG. 15 is a plan view of the RF circuit according to the third modification of the second embodiment. As shown in FIG. 15, in the RF circuit 107 according to the third modification of the second embodiment, the resistive component 35 is not provided. The capacitive component 33 has the same configuration as the capacitive component 33 of the first modification of the second embodiment. The semiconductor chip 36 has electrodes 35C and 36D, the transistor Q2, and the resistor R1.

The bonding wires 43 and 44 are electrically connected to the electrode 33C of the capacitive component 33. Each bonding wire 46 electrically connects the electrodes 33B and 35C. Examples of inductance, capacitance, and resistance are the same as those in Tables 1 to 5. Other configurations are the same as those in the first modification of the second embodiment, and description thereof is omitted.

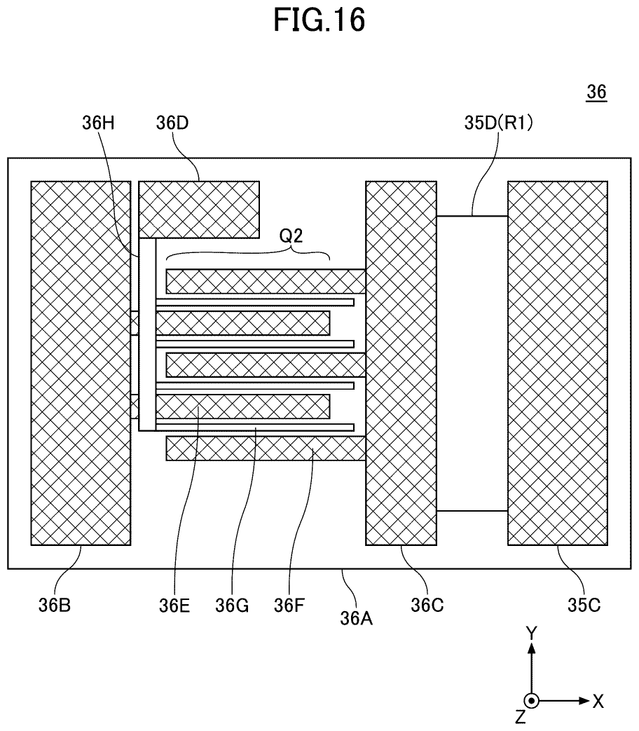

FIG. 16 is a plan view of the semiconductor chip in the third modification of the second embodiment. As shown in FIG. 16, an electrode 35C and a resistor 35D are provided on a semiconductor substrate 36A. The resistor 35D that forms the resistor R1 is connected between the electrodes 36C and 35C. Thus, the resistor R1 and the transistor Q2 are connected in series between the electrodes 35C and 36B. The electrode 36B is electrically connected to the base 20 by via(s) or bonding wire(s) extending through the semiconductor substrate 36A and is short-circuited. Other configurations are the same as those in FIG. 6 of the first modification of the first embodiment.

### Fourth Modification of Second Embodiment

In a fourth modification of the second embodiment, the switch SW1 is connected between the first circuit 10 and the reference potential terminal, a high-pass matching circuit is used as the matching circuit 12, and the transistor Q2 and the resistor R1 are provided on the same semiconductor chip.

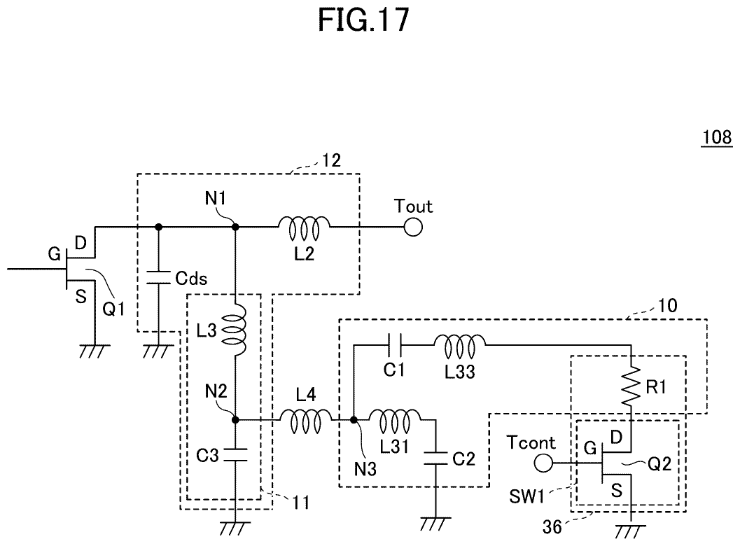

FIG. 17 is a circuit diagram of the RF circuit according to the fourth modification of the second embodiment. As shown in FIG. 17, in an RF circuit 108 according to the fourth modification of the second embodiment, between the node N3 and the drain D of the transistor Q2, the capacitor C1, the inductor L33, and the resistor R1 are connected in series in this order from the node N3. The transistor Q1 and the resistor R1 are formed on the semiconductor chip 36.

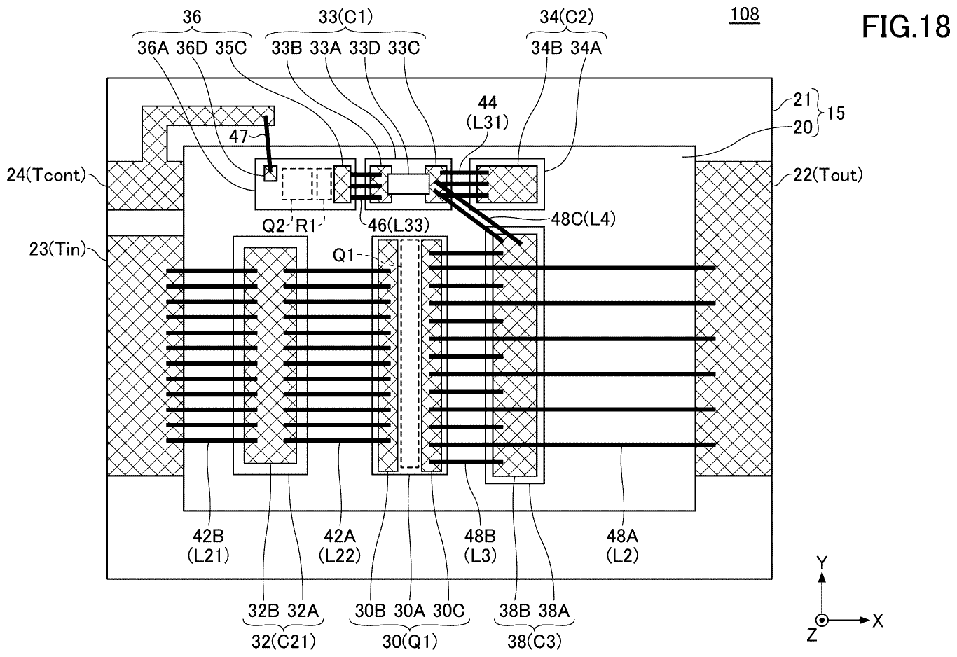

FIG. 18 is a plan view of the RF circuit according to the fourth modification of the second embodiment. As shown in FIG. 18, in an RF circuit 108 according to the fourth modification of the second embodiment, the resistive element 35 is not provided. The capacitive component 33 and the semiconductor chip 36 have the same configuration as the capacitive component 33 and the semiconductor chip 36 in the third modification of the second embodiment. The bonding wires 48C and 44 are electrically connected to the electrode 33C of the capacitive component 33. Examples of inductances, capacitances, and resistances are the same as those in Tables 1 and 3 to 6. Other configurations are the same as those in the second modification and the third modification of the second embodiment, and description thereof is omitted.

In the third modification and the fourth modification of the second embodiment, the semiconductor chip 36 can be made compact by providing the transistor Q2 and the resistor R1. When the transistor Q2 is a GaN HEMT, the semiconductor substrate 36A is a substrate having high thermal conductivity, such as a silicon carbide substrate. Therefore, heat dissipation from the resistor R1 can be improved.

### Fifth Modification of Second Embodiment

In a fifth modification of the second embodiment, the switch SW1 is connected between the first circuit 10 and the reference potential terminal, a low-pass matching circuit is used as the matching circuit 12, and the transistor Q2, the resistor R1, and the capacitor C1 are provided on the same semiconductor chip.

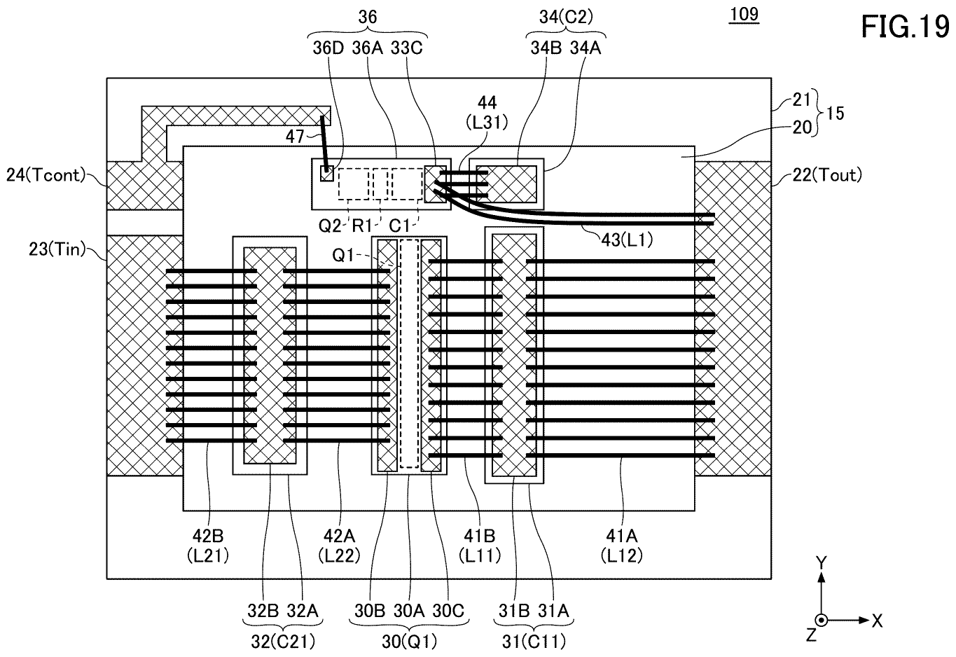

FIG. 19 is a plan view of the RF circuit according to the fifth modification of the second embodiment. As shown in FIG. 19, in an RF circuit 109 according to the fifth modification of the second embodiment, the resistive element 35 and the capacitive component 33 are not provided. The semiconductor chip 36 has electrodes 33C and 36D, the transistor Q2, the resistor R1, and the capacitor C1.

The bonding wires 43 and 44 are electrically connected to the electrode 33C of the semiconductor chip 36. Examples of inductances, capacitances, and resistances are the same as those in Tables 1 to 5. Other configurations are the same as those in the first modification of the second embodiment, and description thereof is omitted.

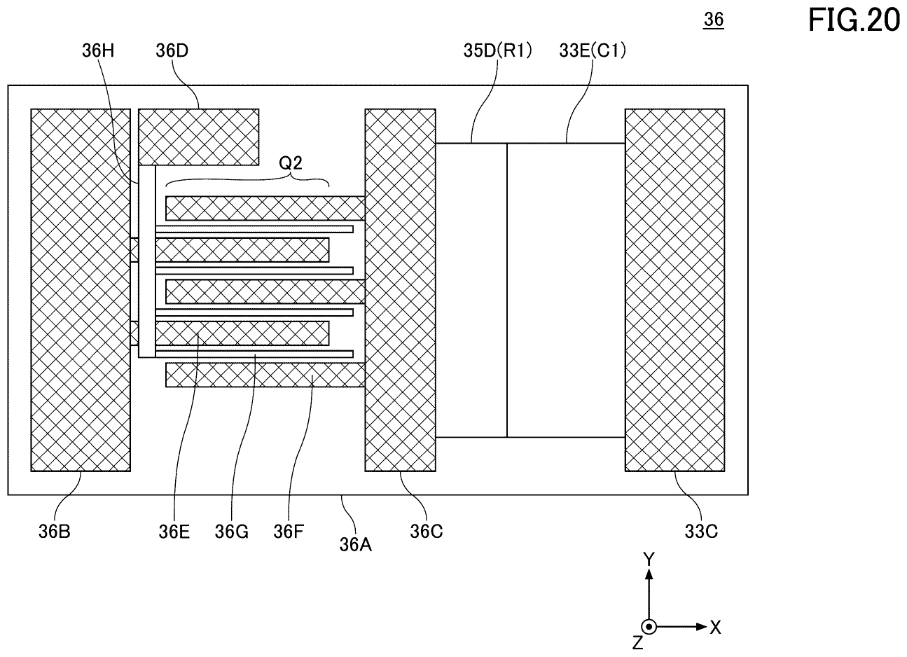

FIG. 20 is a plan view of the semiconductor chip in the fifth modification of the second embodiment. As shown in FIG. 20, an electrode 33C and a capacitor 33E are provided on the semiconductor substrate 36A. The resistor R1 and the capacitor 33E are connected in series between the electrodes 36C and 33C. Thus, the capacitor C1, the resistor R1, and the transistor Q2 are connected in series between the electrodes 33C and 36B. Other configurations are the same as those in FIG. 16 of the third modification of the second embodiment.

### Sixth Modification of Second Embodiment

A sixth modification of the second embodiment is an example in which the switch SW1 is connected between the first circuit 10 and the reference potential terminal, a high-pass matching circuit is used as the matching circuit 12, and the transistor Q2, the resistor R1, and the capacitor C1 are provided on the same semiconductor chip.

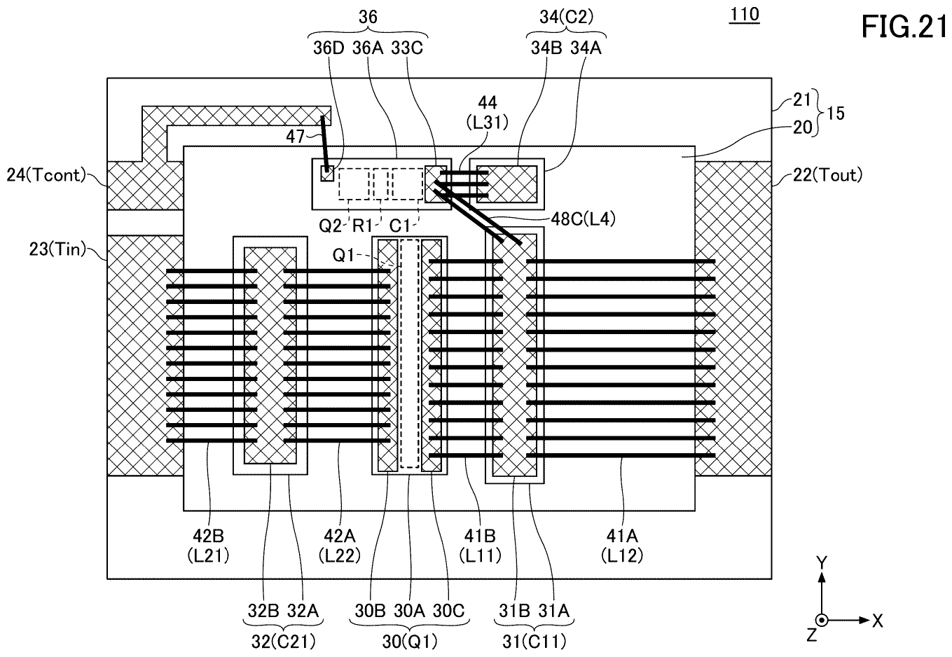

FIG. 21 is a plan view of the RF circuit according to the sixth modification of the second embodiment. As shown in FIG. 21, in an RF circuit 110 according to the sixth modification of the second embodiment, the resistive element 35 and the capacitive component 33 are not provided. The semiconductor chip 36 is the same as the semiconductor chip 36 of the fifth modification of the second embodiment. The bonding wires 48C and 44 are electrically connected to the electrode 33C of the semiconductor chip 36. Examples of inductances, capacitances, and resistances are the same as those of Tables 1 and 3 to 6. Other configurations are the same as those of the second modification and the fifth modification of the second embodiment, and description thereof is omitted.

In the fifth modification and the sixth modification of the second embodiment, the semiconductor chip 36 can be made compact by providing the transistor Q2, the resistor R1, and the capacitor C1. When the transistor Q2 is a GaN HEMT, the semiconductor substrate 36A is a substrate having high thermal conductivity such as a silicon carbide substrate. Therefore, heat dissipation from the resistor R1 can be improved.

As in the third to sixth modifications of the second embodiment, at least one of the resistor R1, the capacitor C1, or the capacitor C2 may be integrated on the semiconductor chip 36. Two or more of the resistor R1 and the capacitors C1 and C2 may be integrated on a chip different from the semiconductor chip 36.

### Seventh Modification of Second Embodiment

A seventh modification of the second embodiment is an example in which the switch SW1 is connected between the first circuit 10 and the reference potential terminal, a low-pass matching circuit is used as the matching circuit 12, and the transistors Q1 and Q2 and the resistor R1 are provided on the same semiconductor chip.

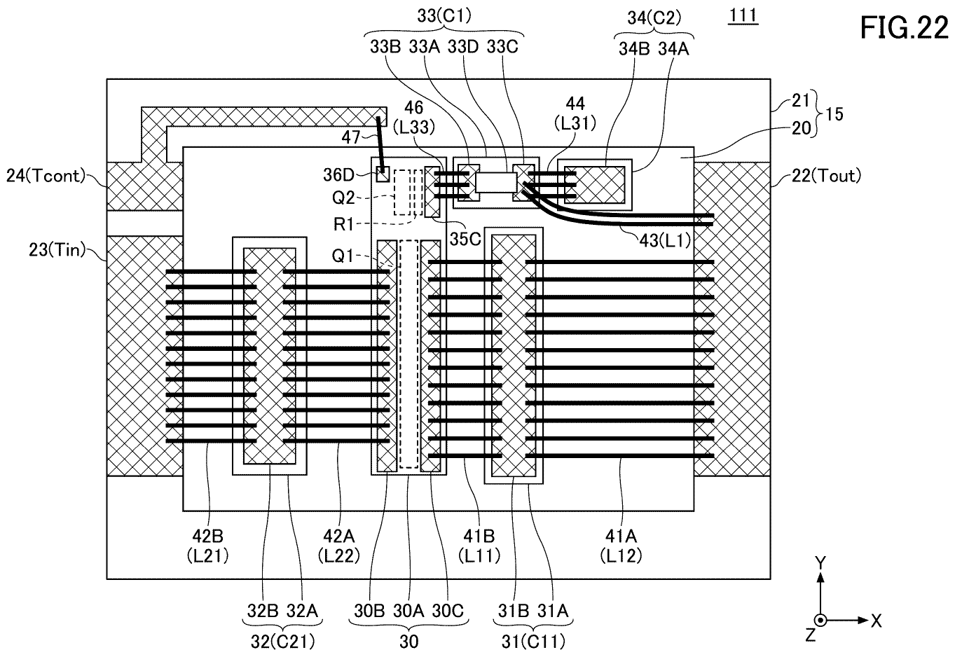

FIG. 22 is a plan view of the RF circuit according to the seventh modification of the second embodiment. As shown in FIG. 22, in an RF circuit 111 according to the seventh modification of the second embodiment, the resistive element 35 and the semiconductor chip 36 are not provided. The semiconductor chip 30 has electrodes 35C and 36D, the transistor Q2, and the resistor R1. The bonding wires 46 are electrically connected to the electrode 35C of the semiconductor chip 30. Examples of inductances, capacitances, and resistances are the same as those in Tables 1 to 5. Other configurations are the same as those in the first modification of the second embodiment, and description thereof is omitted.

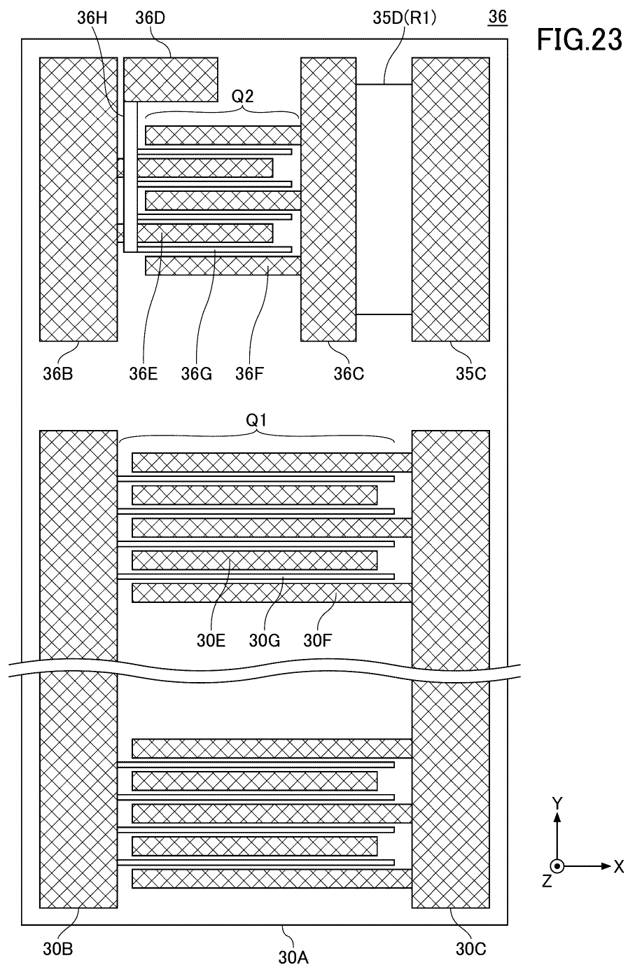

FIG. 23 is a plan view of the semiconductor chip in the seventh modification of the second embodiment. As shown in FIG. 23, electrodes 30B and 30C and the transistor Q1 are provided on a semiconductor substrate 30A. The transistor Q1 has a source electrode 30E, a drain electrode 30F, and a gate electrode 30G. A plurality of source electrodes 30E and a plurality of drain electrodes 30F are alternately provided. One gate electrode 30G is provided between one source electrode 30E and one drain electrode 30F. The plurality of drain electrodes 30F are electrically connected to the electrode 30C in common, and the plurality of gate electrodes 30G are electrically connected to the electrode 30B in common. The plurality of source electrodes 30E are electrically connected and short-circuited to the base 20 via vias extending through the semiconductor substrate 30A. Other configurations are the same as those in FIG. 16 of the third modification of the second embodiment.

### Eighth Modification of Second Embodiment

An eighth modification of the second embodiment is an example in which the switch SW1 is connected between the first circuit 10 and the reference potential terminal, a high-pass matching circuit is used as the matching circuit 12, and transistors Q1 and Q2 and the resistor are provided on the same semiconductor chip.

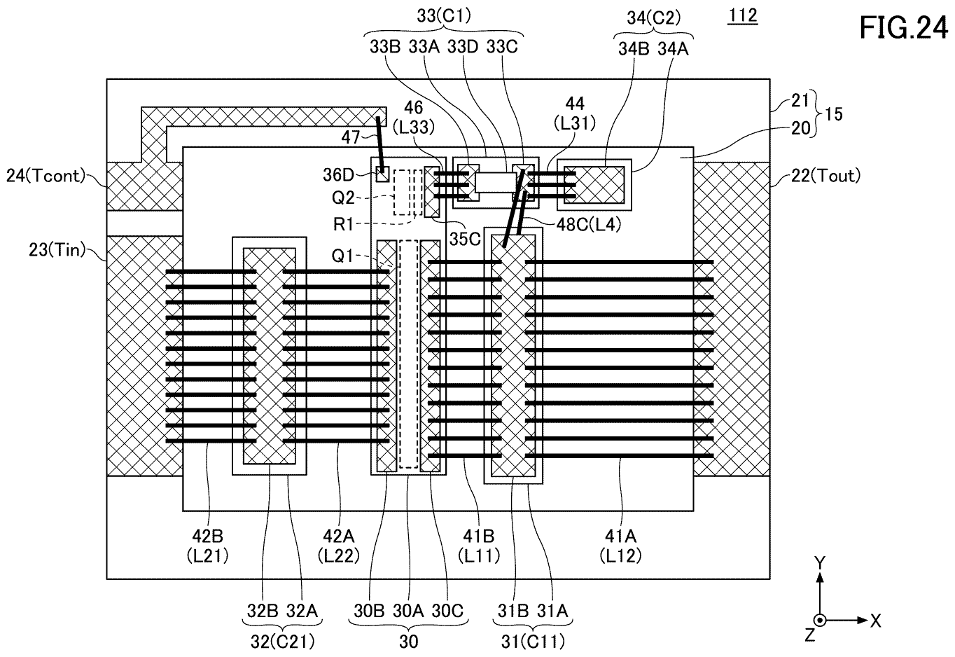

FIG. 24 is a plan view of the RF circuit according to the eighth modification of the second embodiment. As shown in FIG. 24, in an RF circuit 112 according to the eighth modification of the second embodiment, a resistive component 35 and the semiconductor chip 36 are not provided. The semiconductor chip 30 is the same as the semiconductor chip 30 of the seventh modification of the second embodiment. The bonding wires 46 are electrically connected to the electrode 35C of the semiconductor chip 30. Examples of inductances, capacitances, and resistances are the same as those of Tables 1 and 3 to 6. Other configurations are the same as those of the second and seventh modifications of the second embodiment, and description thereof is omitted.

In the seventh modification and the eighth modification of the second embodiment, the transistors Q1 and Q2 and the resistor R1 are provided on the semiconductor chip 30, thereby enabling miniaturization. When the transistor Q1 is a GaN HEMT, the semiconductor substrate 30A is a substrate having high thermal conductivity such as a silicon carbide substrate. Therefore, heat dissipation from the resistor R1 can be improved.

As in the third to eighth modifications of the second embodiment, the transistor Q2 and at least one of the transistor Q1, the resistor R1, and the capacitor C1 may be integrated on the semiconductor chip. This enables miniaturization.

As in the first modification and the second modification of the first embodiment and the first to eighth modifications of the second embodiment, for example, referring to FIG. 5, the RF circuit includes the base 20, the transistor Q1, the output terminal 22 (lead), the transistor Q2 (switch), the resistor R1, and the capacitor C1. The transistors Q1 and Q2, the resistor R1, and the capacitor C1 are provided on the base 20. The output terminal 22 is electrically connected to the transistor Q1. An electrode 36C (first end of a switch) of the transistor Q2 is electrically connected to the output terminal 22. At least one of the resistor R1 or the capacitor C1 is electrically connected to an electrode 36B (a second end of a switch) of the transistor Q2. Thus, the output terminal 22, and the first circuit 10 including at least one of the resistor R1 or the capacitor C1 can be connected and disconnected.

Further, at least the upper surface of the base 20 is conductive. The output terminal 22 is electrically connected to an electrode 30C (second terminal) of the transistor Q1. The electrode 35B (a first end) of the resistor R1 is electrically connected to the electrode 36B (second end of the switch) of the transistor Q2. The capacitor C1 has a first electrode (electrode on the ground side in FIG. 4) and an electrode 33B (second electrode), between which the dielectric substrate 33A is interposed. The first electrode is electrically connected to the base 20, and the electrode 33B is electrically connected to the second end of the resistor R1. Thus, the output terminal 22 and the first circuit 10 including the resistor R1 and the capacitor C1 can be connected and disconnected.

The disclosed embodiments should be considered illustrative and not limiting in all respects. Modifications, changes, combinations, and the like can be made without departing from the scope of the present disclosure.

What is claimed is:

1. A radio frequency (RF) circuit comprising:
an output terminal;
a first transistor including a first terminal, a second terminal, and a control terminal;
a first circuit including a resistor and a first capacitor connected in series between a first node and a reference potential terminal to which a reference potential is supplied, the first node being provided between the second terminal and the output terminal, the first circuit being configured to pass, to the reference potential terminal, a signal component at a frequency lower than an operating band from a high-frequency signal transmitted through the first node; and
a switch configured to connect and disconnect a path passing through the first circuit between the first node and the reference potential terminal.

2. The RF circuit according to claim 1, wherein the switch is connected between the first circuit and the reference potential terminal.

3. The RF circuit according to claim 1, wherein the switch is connected between the first node and the first circuit.

4. The RF circuit according to claim 1, further comprising a second circuit configured to reduce flow of a signal component having a frequency within the operating band from the high-frequency signal into the first circuit.

5. The RF circuit according to claim 4, wherein the second circuit includes an inductor connected in series with the first circuit and the switch, the inductor being between the first node and the reference potential terminal.

6. The RF circuit according to claim 4, wherein the second circuit includes a second node provided between the first node and the first circuit and becoming at the reference potential at any frequency within the operating band.

7. The RF circuit according to claim 1, wherein the first circuit includes a second capacitor connected in parallel with the resistor and the first capacitor, the second capacitor being between a third node and the reference potential terminal, and the third node being provided between the first node, and the resistor and the first capacitor.

8. The RF circuit according to claim 1, wherein the switch is a second transistor including a third terminal, a fourth terminal, and a control terminal, and
wherein the third terminal and the fourth terminal are provided on the path.

9. The RF circuit according to claim 1, wherein an absolute value of impedance of the first capacitor at a frequency that corresponds to a width of the operating band is 10Ω or less.

10. The RF circuit according to claim 8, further comprising:
a base including at least an upper surface that is conductive, the base serving as the reference potential terminal; and
a semiconductor chip mounted on the base,
wherein the second transistor and at least one of the first transistor, the resistor, or the first capacitor are integrated on the semiconductor chip.

11. A radio frequency (RF) circuit comprising:
a base;
a transistor provided on the base;
a lead electrically connected to the transistor;
a switch provided on the base and including a first end electrically connected to the lead; and
at least one of a resistor or a capacitor provided on the base and electrically connected to a second end of the switch.

12. The RF circuit according to claim 11, wherein:
at least an upper surface of the base is conductive,
the transistor includes a first terminal, a second terminal, and a first control terminal,
the lead is electrically connected to the second terminal of the transistor,
a first end of the resistor is electrically connected to the second end of the switch, and
the capacitor includes a first electrode and a second electrode between which a dielectric substrate is interposed, the first electrode being electrically connected to the base, and the second electrode being electrically connected to a second end of the resistor.
